(19) United States
(12) Patent Application Publication
(10) Pub. No.: US 2015/0266188 A1
(43) Pub. Date: Sep. 24, 2015

(54) SPRING ASSIST FOLDING KNIFE

(71) Applicant: Andrew Demko, Wampum, PA (US)

(72) Inventor: Andrew Demko, Wampum, PA (US)

(21) Appl. No.: 14/730,645

(22) Filed: Jun. 4, 2015

Related U.S. Application Data
(63) Continuation-in-part of application No. 13/959,173, filed on Aug. 5, 2013.

(51) Int. Cl. B26B 1/04

(52) U.S. Cl. CPC B26B 1/044

(57) ABSTRACT

A folding knife incorporating an opening assist mechanism that enables the blade from a closed to open position by providing a spring for selective initial blade engagement. A single integral bifurcated spring acts to continuously engage a spring urge locking bar retaining the blade in open locked position and to provide initial spring urged deployment of the blade from blade closed position to blade locked open position during user initiated deployment.

### BACKGROUND OF THE INVENTION

1. Technical Field

This invention relates to folding knives that provide for a knife blade to be pivoted into the handle when not in use. Such folding knives are opened by manual engagement of the blade, pulling it out of the handle and moving it to an open locked use position.

2. Description of Prior Art

Prior art folding knives provide for a blade engagement mechanism that holds the blade in either closed, safely stored position or in extended open and locked use position out of the handle.

Some folding knives are equipped with a so-called assist opening mechanism that typically provides for a spring to hold the blade in closed “folded position” within the handle and then to assist the blade to move to a fully opened locked position.

Thus, as a user would manually first engage the blade from a fully closed position the spring mechanism engages the blade and completes the blade rotation to a fully opened and locked position thus assisting in the opening.

Examples of a variety of such assisted opening folding knives can be seen in U.S. Pat. Nos. 6,959,494, 7,080,457, 7,086,157, 7,107,686, 7,146,736, 7,293,360, 7,313,866, 7,562,454, 7,676,932, 7,748,122 and U.S. Publications 2005/0097754, 2007/0068002, 2007/006800 and 2009/0056146.

U.S. Pat. Nos. 6,959,494, 7,080,457, 7,107,686, U.S. Publication 2005/0097754 and U.S. Pat. No. 7,313,866 all use a combination or specific coil spring configuration to engage and rotate the knife blade from an almost closed position to a fully opened extended and locked position.

U.S. Pat. No. 6,959,495 uses a camming mechanism secured to the blade on which the coil spring engage.

U.S. Pat. No. 7,080,457 has a connecting rod from a spring to a blade.

U.S. Pat. No. 7,107,686 uses a latch cam with an offset pin onto which the coil spring is engaged.

U.S. Publication 2005/0097754 has an activation rod connected between the coil spring and the blade.

U.S. Pat. Nos. 7,086,157 and 7,146,736 use a cantilevered leaf spring that engages the blade while U.S. Pat. No. 7,146,736 has a secondary spring to lever lock the blade in open use position.

A pair of torsion springs held axially on the blade can be seen in U.S. Pat. No. 7,748,122 pivotally rotating force engagement to the blade during activation.

U.S. Pat. Nos. 7,293,360 and 7,562,454 both by the same inventor are directed to a pair of spring arms, one on each lateral side of the blade interconnected by a pin and roller sleeve. U.S. Pat. No. 7,676,932 discloses a folding knife having a spring with the blade to provide opening and closing force thereto.

Finally, in U.S. Patent Publication 2007/0068002 a folding knife is disclosed with a selectively engageable opening mechanism having a spring engaged on one end in an aperture in the blade and the other in a travel slot in the handle. In U.S. Patent Publication 2009/0056146 A1 a knife spring mechanism is claimed having a pair of torsion springs on blade axis pin, with the blade having a pair of oppositely disposed thumb lugs to assist with opening and closing of the blade.

### SUMMARY OF THE INVENTION

A folding knife having a spring assist to fully open the blade from a closed “folded” retained position to an extended and locked position after initial user induced blade movement. A combination integral spring elements selectively engages a drive pin on the blade for initial rotation and release of the blade to an open extended position. A locking arm pivotally engaged and locks the blade open by spring biased engagement with the combination integral spring element. By pivotal engagement of the locking arm, the blade can be rotated under select and intermediate main spring engagement and compression to a closed retained locked position as hereinbefore described.

### DESCRIPTION OF THE DRAWINGS

FIG. 1 is a side elevational view of the folding knife of the invention with portions broken away in open locked position.

FIG. 2 is a partial top plan view of the folding knife in open locked position shown in FIG. 1.

FIG. 3 is an enlarged partial side elevational view in closed locked position.

FIG. 4 is an enlarged partial side elevational view of the assisted opening folding knife as it opens illustrated in broken and solid lines or progressively as it closes.

FIG. 5 is a side elevational view of an alternate folding knife of the invention with portions broken away in open locked position.

FIG. 5 is a side elevation view of an alternate folding knife of the invention with portions broken away in open locked position.

FIG. 6 is a partial top plan view thereof.

FIG. 7 is a side elevational view of the folding knife of FIG. 5 in closed position.

FIG. 8 is partial side elevational view of the alternate assisted opening folding knife as it opens and closes.

### DETAILED DESCRIPTION OF THE INVENTION

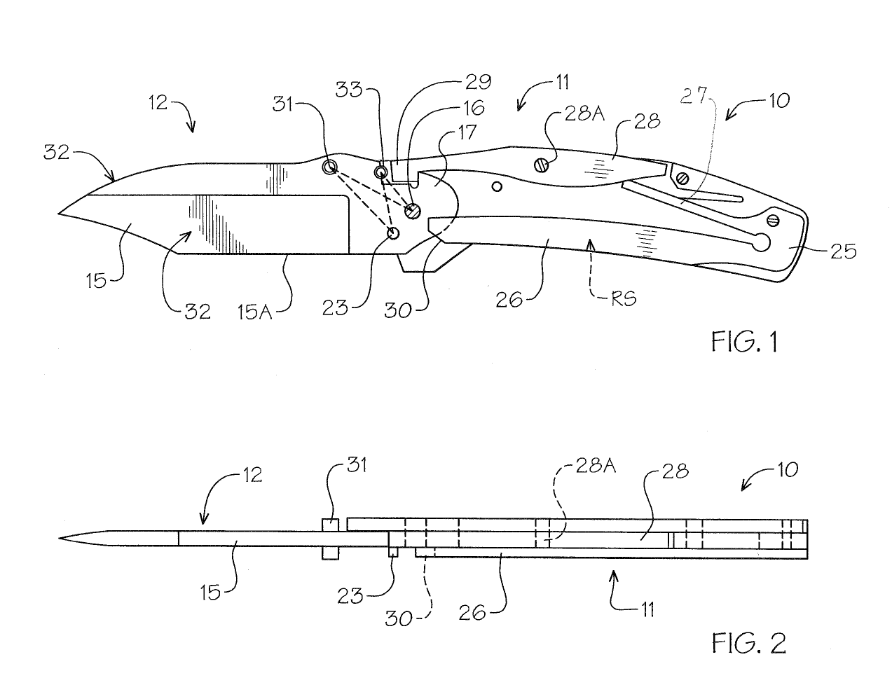

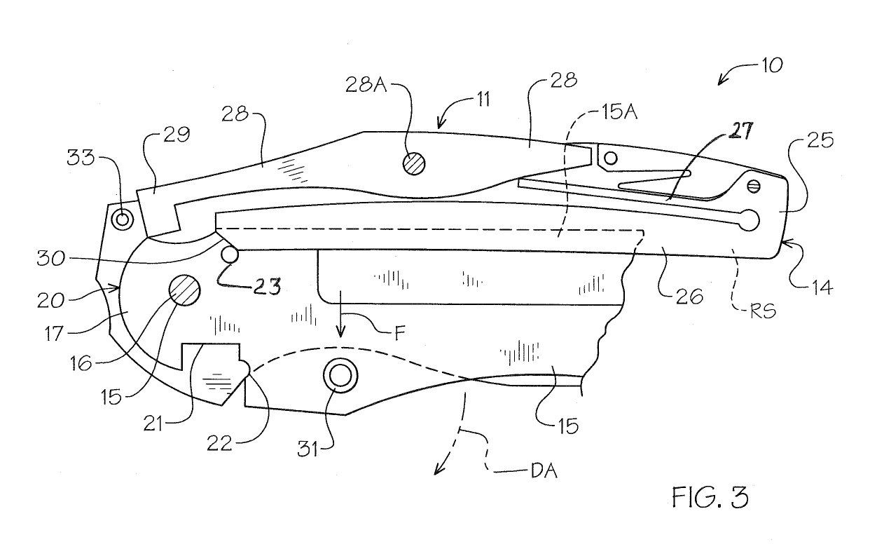

Referring to FIGS. 1 and 2 of the drawings, an assisted opening knife 10 of the invention can be seen in the unfolded open lock position. The knife 10 has a handle portion 11 and a blade portion 12 pivotally secured thereto. The handle portion 11 has a support frame element 13 with a spring assist assembly 14 positioned therewithin. The blade portion 12 defines a blade 15 that is pivotally secured by a hinge pin 16 therethrough so as to be removably disposed within a blade retention slot RS so defined within the handle portion 11. Accordingly, a sharpened blade edge 15A on the blade 15 is safely enclosed therewithin as seen in FIG. 3 of the drawings.

The blade 15 has a shank portion 17 with an aperture at 18 through which the hinge pin 16 extends pivotally securing the blade 15 to the handle portion 11 as hereinbefore described. The shank portion 17 has a partial arcuate end edge 20 with a retainment receiving shank hook 21 and oppositely disposed blade stop notch 22 formed therein. The shank portion 17 also has a spring arm engageable deployment pin 23 extending therefrom in spaced relation to the blade hinge pin 16 and correspondingly blade back edge 24 as best seen in FIG. 1 of the drawings.

Referring now to the spring assist assembly 14, it can be seen that it comprises a bifurcated spring arm element 25 secured within the handle portion 11 having a main blade engagement spring extension arm 26 and the bifurcated foreshortened locking bar engagement spring extension arm 27. A pivoted locking bar 28 with a pivot pin 28A is engaged by the spring arm 27 and has an oppositely disposed corresponding blade engagement notch free end portion 29 for selective engagement on the shank hook 21 when in unfolded locked position as again seen in FIG. 1 of the drawings.

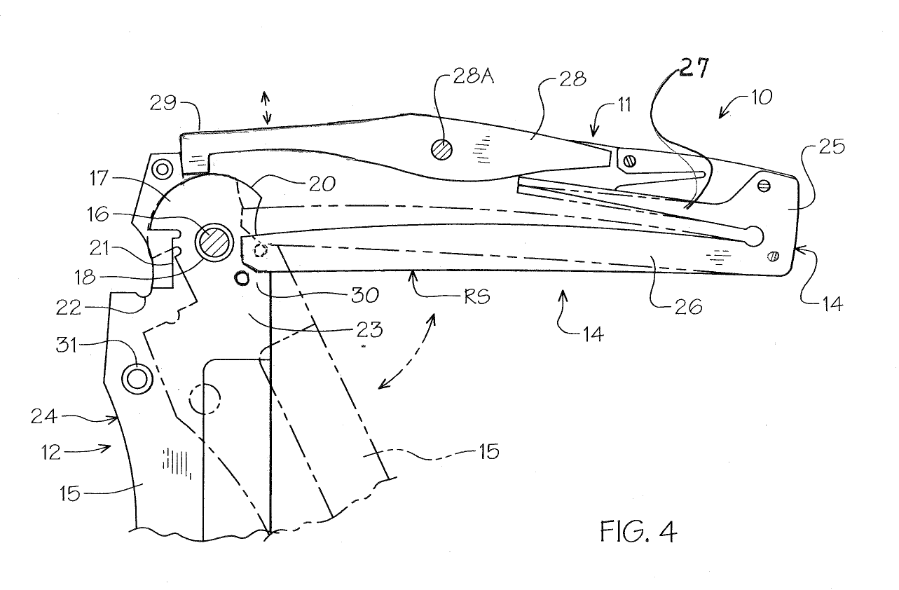

The spring extension arm 26 correspondingly has a angled end edge corner surface 30 that is engaged against the upstanding deployment pin 23 as the blade 15 is rotated into the blade retainment slot RS in the handle portion 11 as seen in broken and solid lines in FIG. 4 of the drawings. Correspondingly, the free end portion 29 of the locking bar 28 rests against the intermediate arcuate edge 20 on the shank portion 17 when so engaged.

It will be evident from the above description that the spring extension arm 26 will be displaced under tension by the deployment pin 23 there against as the blade 15 is rotated into a closed position within the handle portion, thus preloading the blade for spring assist opening as will be described hereinafter.

It can be seen that the associated geometry imparted by the blade hinge pin 16, the so positioned deployment pin 23, and registerable shank end surface 20 allows for the blade 15 assisted release and full open deployment in the following sequence under user's initial action.

For assisted blade 15 deployment from the closed position, the user (not shown) engages oppositely disposed thumb lugs 31 indicated by force arrow F which extends from the back blade surface in spaced relation to the shank hook 29, best seen in FIG. 3 of the drawings. As noted, in the blade closed position, the edge corner surface 30 of the blade extension arm 26 is initially engaged on the deployment pin 23 under tension so that once the “user” initiates the hereinbefore described movement of the thumb lugs 31, the blade 15 rotates as indicated by broken line directional arrows DA under spring tension. The engagement portion of the deployment pin 23 on the spring arm end edge corner 30 surface travels therealong driving the rotation of the knife blade 15 as seen from broken to solid lines in FIG. 4 of the drawings. The rotational momentum imparted thereby propels the blade 15 to fully extended and locked position indicated at 32 as best seen in FIG. 1 of the drawings. The blade 15 engages a blade stop pin 33 extending from the handle frame 13 in the shank stop notch 22 while the locking bar 28 free end 29 engages within the shank hook 21.

The locking bar 28 is, as noted, spring urged by the foreshortened spring arm 27 assuring a positive engagement as it travels around the arcuate end edge 20 of the shank portion 17 before locking engagement, as noted, within the shank hook portion 21.

It will be seen that by utilization of a bifurcated spring arm 25 which selectively engages with a geometrically and translaterly positioned deployment pin 23 on the shank portion 17 of the blade 15 will once the blade 17 is initiated by user be propelled outwardly from the handle portion by the spring urged rotation on the pivot hinge 16 to a fully open and locked position in longitudinal alignment with the handle portion 11 as seen in FIG. 1 of the drawings.

As hereinbefore described, the blade 15 will engage the blade stop pin 33 and the spring urged locking bar 28's free end 29 will accordingly pivot into registration within the blade hook 21 locking the blade 17 in place.

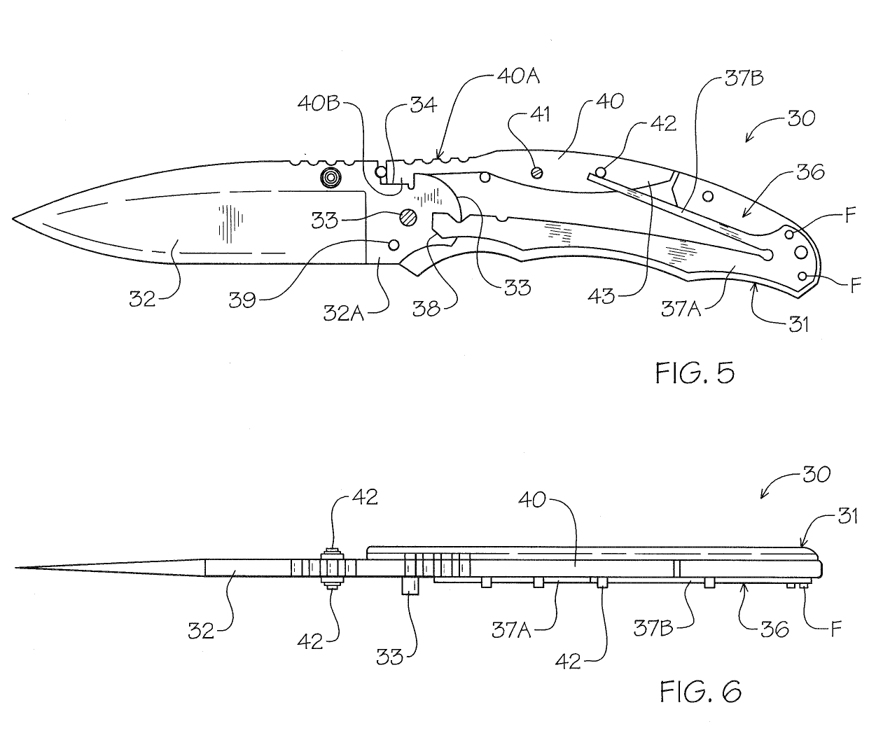

Referring now to FIGS. 5 and 6 of the drawings, an alternate assisted opening knife 30 can be seen in unfolded open use locked position. The knife 30 has a handle 31 with a blade 32 pivotally secured thereto on a hinge pin 33. The blade 32 has a shank portion 32A with an arcuate end engagement edge 33 with a shank hook 34 and oppositely disposed blade stop notch 35 therein, as hereinbefore described in the primary form of the invention of the knife 10.

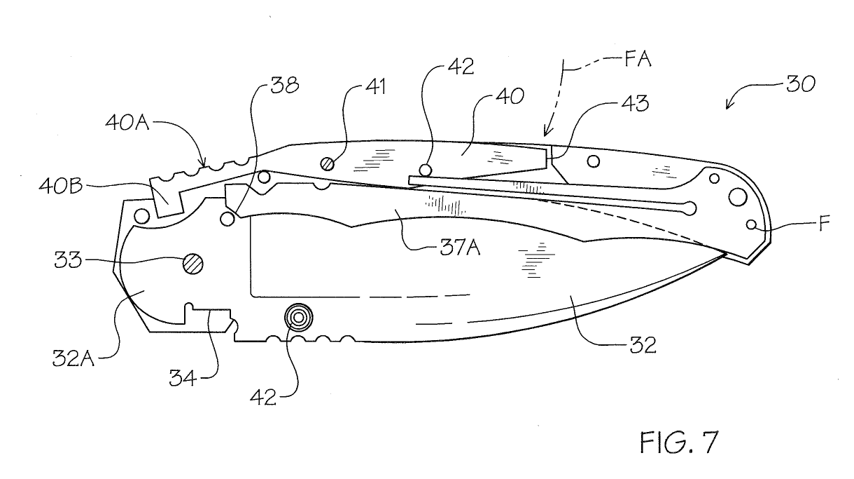

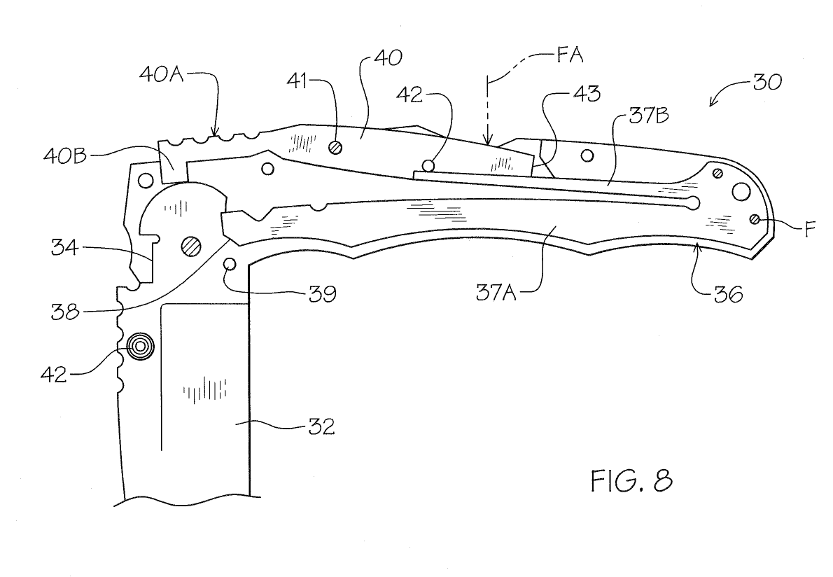

An alternate modified spring assist assembly 36 is mounted within the handle 31 by multiple fasteners F and has corresponding duel interconnected spring arms 37A and 37B. The spring arm 37A has an end corner angle blade engagement surface 38 that is selectively engaged on an upstanding blade deployment pin 39, which extends from the shank portion 32A of the blade 32 when going from a pivotally open position shown in FIG. 8 to a fully closed position as seen in FIG. 7 of the drawings.

A pivoted blade locking bar 40 is mounted within the handle 31 on a pivot pin 41 and has a upstanding spring engagement pin 42 positioned midway between the pivot pin 41 and its end at 43, which is in constant spring urge contact with the spring arm 37B as seen in FIG. 7 of the drawings in closed blade position to fully opened blade position, shown in FIG. 5 of the drawings.

The blade locking bar 40 has a tapered blade engagement end 40A defining a tab 40B extending therefrom that is selectively engaged within the shank hook 34 when the blade 32 is in open locked position as illustrated.

In operation, to release the blade 32 from the lock open position, the locking bar 40 is depressed (see force arrow FA) by user (not shown) against the spring arm 32 pivoting blade engagement tab 40B upwardly out of registration within the shank hook 34 engagement.

Once released, the blade 32 is then rotated to close position in the handle 31 with the shank deployment pin 39 engaging the spring arm 32A which will be displaced under tension as the blade is closed within the handle 31, thereby preloading the blade 32 for a spring urged assist during opening, as will be described hereinafter.

As noted, for assisted blade 32 deployment from the blade closed spring balance position, the user (not shown) engages one of the oppositely disposed thumb lugs 42 which extend in oppositely disposed relation from the blade in space relation to the shank hook, as best seen in FIG. 7 of the drawings. Given that in the blade closed position the edge corner surface 38 of the spring arm 37A is initially engaged on the shank deployment pin 39 under balance tension, so once opening is initiated by user engagement of the hereinbefore described thumb lugs 42, the spring arm 32A will drive the blade 32 outwardly to a point of pin arm release 39, seen in FIG. 8 of the drawings, propelling the blade to full locking extended position as seen in FIG. 5 of the drawings.

It will be evident that when fully deployed, the blade 32 will be automatically locked in place by the spring engagement of the hereinbefore described locking bar end tab 40B within the shank hook 34 as noted.

It will thus be seen that a new and novel spring assisted opening folding knife configuration has been illustrated and described and it will be apparent to those skilled in the art that various changes and modifications may be made therein without departing from the spirit of the invention. Therefore, I claim:

1. An improvement for a folding knife having,
an elongated handle with an elongated knife blade pivotally secured thereto for movement of the blade from a first closed position within the handle to a locked open position extending from said handle,
said knife blade having a sharpened edge portion, a shank end portion within said handle, oppositely disposed lugs extending from said blade, an upstanding blade deployment pin on said shank end portion,
a spring urged locking bar within said handle retaining said blade in a locked open position,
a bifurcated spring with dual spring arms within said handle portion for selective end edge registration with said blade deployment pin and continuous registration against said locking bar.

2. The improvement to a folding knife of claim 1 wherein one of said spring arms has an end edge corner surface registerable with said shank blade deployment pin, exerting an initial opening engagement force configured to propel the blade freely to a fully opened position.

3. The improvement in a folding knife set forth in claim 1 wherein said shank portion has a shank hook therein registerable with a locking bar end tab when in blade first closed position.

4. The improvement in a folding knife set forth in claim 1 wherein said handle has a blade stop pin registerable on said shank portion, when said blade is in said locked open position.

5. The improvement in a folding knife set forth in claim 3 wherein said locking bar is pivoted from said blade first closed position to engaging an arcuate end edge of said shank end portion to a second blade locked open position engaged in said shank hook.

6. The improvement for a folding knife set forth in claim 1 wherein said knife pivot pin, said blade deployment pin and one of said oppositely disposed lugs define a geometric triangle pivoting about which said knife blade pivots from a blade first closed position in said handle to a second blade lock position extending from said handle.

7. The improvement for a folding knife set forth in claim 1 wherein said spring arms are of an unequal length and unequal transverse dimension in respect to one another.
